(19) United States
(12) Patent Application Publication
(10) Pub. No.: US 2024/0127119 A1
(43) Pub. Date: Apr. 18, 2024

(54) Management Of Multiple Machine Learning Model Pipelines

(71) Applicant: Oracle International Corporation, Redwood Shores, CA (US)

(72) Inventors: Andrew Ioannou, San Francisco, CA (US); Miroslav Novák, Prague (CZ); Petr Dousa, Prague (CZ); Martin Panacek, Zlin (CZ); Hari Ganesh Natarajan, Redmond, WA (US); David Kalivoda, Pardubice (CZ); Vojtech Janota, Prague (CZ); Zdenek Pesek, Teplice (CZ); Jan Pridal, Olomouc (CZ)

(73) Assignee: Oracle International Corporation, Redwood Shores, CA (US)

(21) Appl. No.: 18/461,378

(22) Filed: Sep. 5, 2023

Related U.S. Application Data
(60) Provisional application No. 63/416,579, filed on Oct. 16, 2022.

(51) Int. Cl. G06N 20/00

(52) U.S. Cl. CPC G06N 20/00

(57) ABSTRACT

In one or more embodiments, a software service allows software providers to implement machine learning (ML) features into products offered by the software providers. Each ML feature may be referred to as an encapsulated ML application, which may be defined and maintained in a central repository, while also being provisioned for each user of the software provider on an as-needed basis. Advantageously, embodiments allow for a central definition for an ML application that encapsulates data science and processing capabilities and routines of the software provider. This central ML application delivers a ML deployment pipeline template that may be replicated multiple times as separate, tailored runtime pipeline instances on a per-user basis. Each runtime pipeline instance accounts for differences in the specific data of each user, resulting in user-specific ML models and predictions based on the same central ML application.

### INCORPORATION BY REFERENCE; DISCLAIMER

The following application is hereby incorporated by reference: application No. 63/416,579 filed on Oct. 16, 2022. The applicant hereby rescinds any disclaimer of claims scope in the parent application(s) or the prosecution history thereof and advises the USPTO that the claims in the application may be broader than any claim in the parent application(s).

### TECHNICAL FIELD

The present disclosure relates to machine learning models, pipelines, and applications, and more specifically to instantiating, providing, and operating machine learning models, pipelines, and applications as a service.

### BACKGROUND

When a software provider attempts to deploy machine learning (ML) applications, there are currently many different solutions available to the software provider. Some of these solutions offer automated instantiation on the software provider-side, such as with software-as-a-service (SaaS)-based solutions. Other solutions rely on a software provider learning how to perform instantiation, sometimes by trial and error. However, each of these conventional solutions suffer from multiple issues. Mass instantiation of multiple ML pipelines often involves extensive time and expense on the software provider-side to ensure security, functionality, and interoperability of the various ML pipelines within the existing software and hardware environment of the software provider.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1A-1C illustrate an example system in accordance with one or more embodiments;

FIG. 2 illustrates an example method for instantiating a ML application instance in accordance with one or more embodiments;

FIG. 3 illustrates an example method for provisioning multiple ML deployment pipelines based on a ML deployment pipeline template, in accordance with one or more embodiments;

FIG. 4 illustrates an example ML architecture, in accordance with one or more embodiments;

FIG. 5 illustrates an example ML application implementation template and an example ML application instance, in accordance with one or more embodiments; and

FIG. 6 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. SYSTEM FOR MANAGING MULTIPLE MACHINE LEARNING MODEL PIPELINES
3. EXAMPLE EMBODIMENTS
   3.1 INSTANTIATING A MACHINE LEARNING INSTANCE
   3.2 PROVISIONING MULTIPLE MACHINE LEARNING DEPLOYMENT PIPELINES BASED ON A MACHINE LEARNING DEPLOYMENT PIPELINE TEMPLATE
   3.3 MACHINE LEARNING AS A SERVICE ON DEMAND
   3.4 MACHINE LEARNING ARCHITECTURE
   3.5 MACHINE LEARNING APPLICATION DETAILS
4. COMPUTER NETWORKS AND CLOUD NETWORKS
5. MISCELLANEOUS; EXTENSIONS
6. HARDWARE OVERVIEW

### 1. General Overview

One or more embodiments execute a machine learning (ML) application defined by a ML application definition. The ML application receives user input including template configuration data for use in generating an ML application implementation template. Based on the template configuration data, the ML application generates a particular ML application implementation template. The ML application generates a ML application instance based on the ML application implementation template. Specifically, the ML application implementation template is used to determine a ML model, a data ingestion pipeline, and a prediction output pipeline. The system links together the ML model, the data ingestion pipeline, and the prediction output pipeline to generate the ML application instance.

Advantageously, embodiments allow for a central definition for an ML application that encapsulates data science and processing capabilities and routines of the software provider. This central ML application generates a ML deployment pipeline template that may be replicated multiple times as separate, tailored runtime pipeline instances on a per-user basis. Each runtime pipeline instance accounts for differences in the specific data of each user, resulting in user-specific ML models and predictions based on the same central ML application.

Advantageously, embodiments allow for software providers to have their software updated (e.g., roll out a new product feature) across instances of the software, while still training each ML model to account for the differences in data for each individual user to deliver user-specific ML models and predictions based on the same central ML application.

One or more embodiments described in this Specification and/or recited in the claims may not be included in this General Overview section.

### 2. System for Managing Multiple Machine Learning Model Pipelines

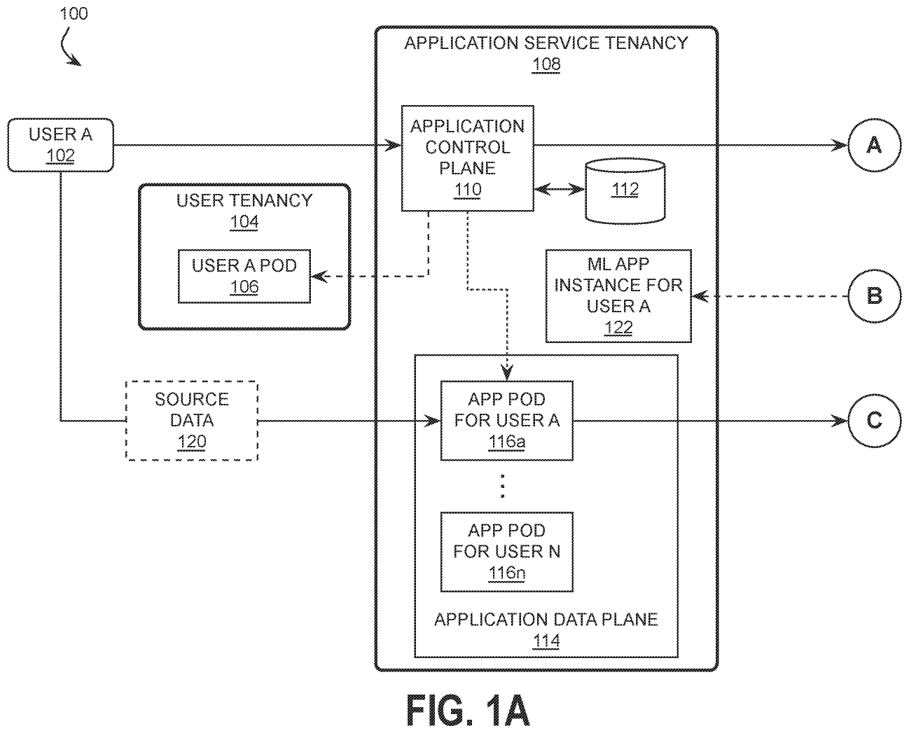

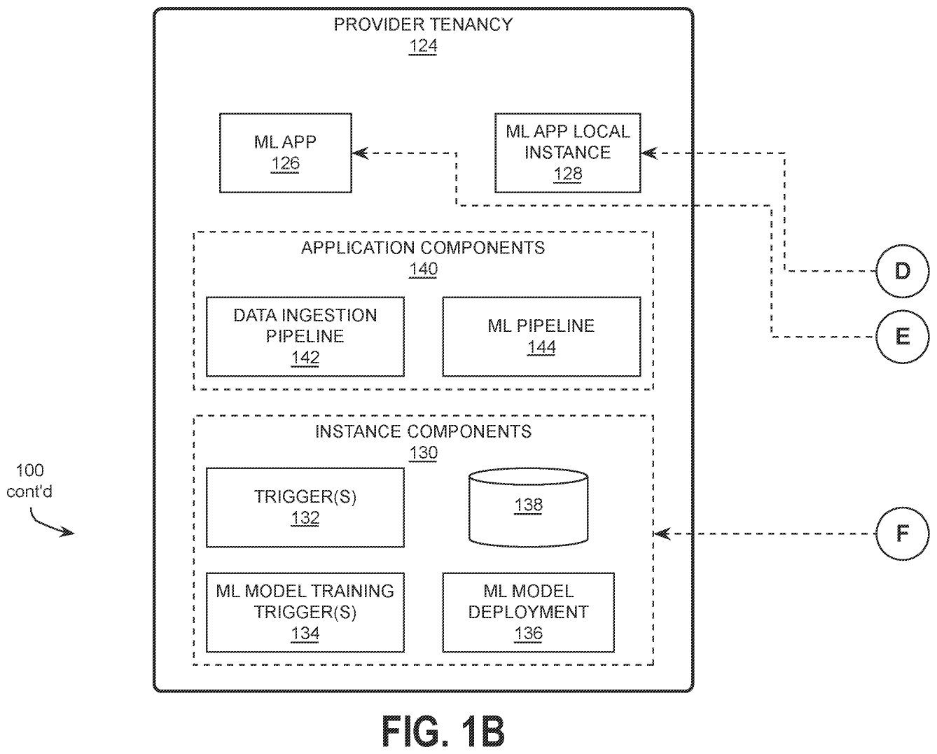

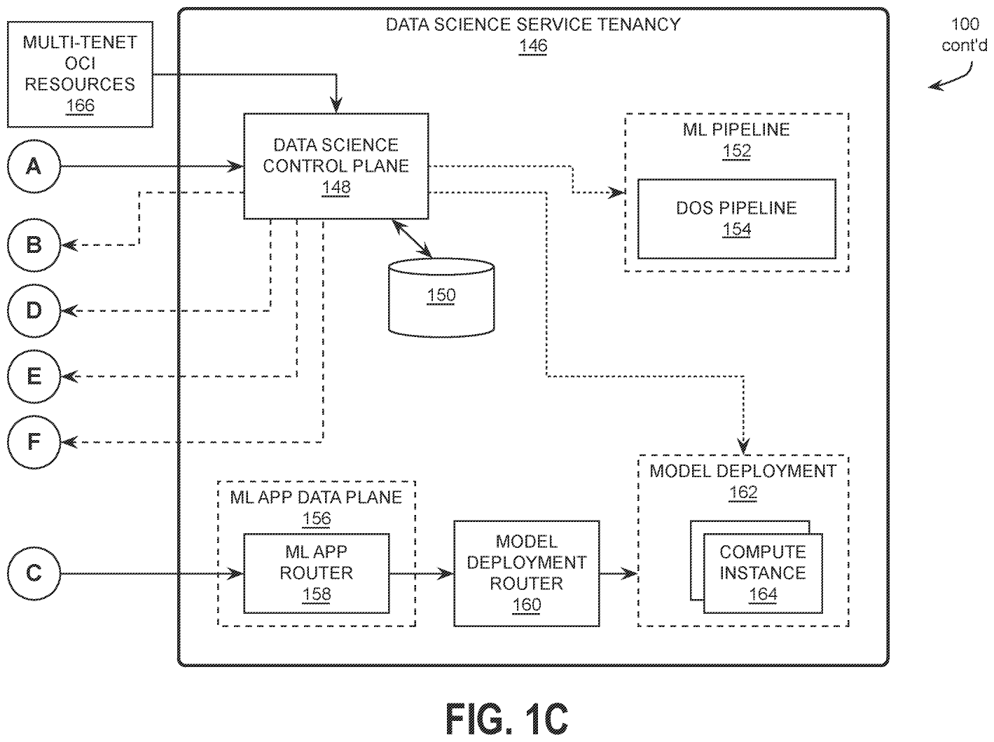

FIGS. 1A-1C illustrate a system 100 for creating and managing multiple ML model pipelines and/or ML application instances.

In one or more embodiments, system 100 may include more or fewer components than the components illustrated in FIGS. 1A-1C. The components illustrated in FIGS. 1A-1C may be local to or remote from each other. The components illustrated in FIGS. 1A-1C may be implemented in software and/or hardware. Each component may be distributed over multiple applications and/or machines. Multiple components may be combined into one application and/or machine. Operations described with respect to one component may instead be performed by another component.

FIG. 1A shows a portion of system 100, having a user tenancy 104 in communication with an application service tenancy 108. User A 102 interacts with application service tenancy 108 (e.g., via a user interface) within an application control plane 110. Based on user A 102 interactions, a point of delivery (PoD) 106 for user A is generated within the user tenancy 104. Application control plane 110 makes use of a data repository 112 for storage and retrieval of data related to PoD 106.

In one or more embodiments, data repository 112 may be used to store information for system 100, and may be any type of storage unit and/or device (e.g., a file system, database, collection of tables, or any other storage mechanism) for storing data. Further, the data repository 112 may include multiple different storage units and/or devices. The multiple different storage units and/or devices may or may not be of the same type or located at the same physical site. Further, the data repository 112 may be implemented or may execute on the same computing system as the system 100. Alternatively or additionally, the data repository 112 may be implemented or executed on a computing system separate from system 100. The data repository 112 may be communicatively coupled to any device for transmission and receipt of data via a direct connection or via a network.

Moreover, application control plane 110 provisions an application PoD 116a for user A in the application data plane 114. Application control plane 110 also provisions any other application PoDs for other users (e.g., application PoD 116n for user N) within the application data plane 114. Application PoD 116a for user A is operable to request one or more predictions to be made (circle C), which are sent to the ML application data plane 156 (shown in FIG. 1C).

User A 102 enters source data 120 to the application data plane 114 which may be presented to other components within system 100. The application control plane 110 sends a request (circle A) for provisioning of the ML application instance 122 for user A to the data science control plane 148 (shown in FIG. 1C). ML application instance 122 for user A is provisioned (circle B) within the application service tenancy 108 for delivering ML model predictions, in various approaches, and for execution with source data 120 from user A 102. ML application instance 122 for user A may be created and/or generated in the user tenancy 104, such as for situations where user A 102 intends to manage ML application instance 122 directly, instead of relying on the application control plane 110. In FIG. 1A, ML application instance 122 resides in the application service tenancy 108 in an embodiment. In one or more alternate embodiments, ML application instance 122 may be created directly by user A 102 and reside in user tenancy 104.

In FIG. 1B, another portion of system 100 is shown having a provider tenancy 124 that includes application components 140 and instance components 130. The application components 140 may be used for provisioning, managing, maintaining, and/or supporting ML application instances across the various users, including ML application instance 122 for user A. The application components 140 are shared across the various ML application instances. Application components 140 may include a data ingestion pipeline 142 and a ML pipeline 144. The data ingestion pipeline 142 is configured for retrieving source data for particular users (such as user A 102) and converting/transforming the source data into target data suitable for use with one or more ML models operating for an ML application instance 122. The ML pipeline 144 orchestrates ML tests, including but not limited to, data normalization, feature generation, training, hyper-parameter tuning, model deployment, etc. The ML pipeline 144 delivers functionality and constraints to enable the ML application instances across the various users, including ML application instance 122 for user A.

In provider tenancy 124 of system 100, instance components 130 may be used for supporting ML application instance 122 for user A. The instance components 130 are specific to ML application instance 122 for user A and are not used by any other ML application instances. Instance components 130 include one or more triggers 132 which define conditions and/or situations where the data ingestion pipeline 142 will operate to ingest source data for system 100, along with possible constraints and/or limits on that source data. One or more ML model training triggers 134 are operable to dictate and define conditions and/or situations where a ML model in ML model deployment 136 for ML application instance 122 for user A will be trained with new data and/or updated data that is targeted for training the ML model. ML model training trigger(s) 134 operate to define when the ML model will be trained, such as when performance metrics do not achieve a performance threshold, along with possible constraints and/or limits on the training (such as time periods for training, amount of time used for training, number of training sets to use, schedules that ensure periodic execution of ML pipeline 144 via trigger(s) 132, etc.). A schedule is a resource that can periodically initiate an action, such as activating a trigger 132 that initiates execution of ML pipeline 144.

ML model deployment 136 includes one or more ML models for ML application instance 122 for user A. Instance components 130 also include a data repository 138 (e.g., a database, data lake(s), bucket, etc.) for storage and retrieval of information relevant to the instance components 130. Provider tenancy 124 also includes an ML application 126, which may be used for any of the various users and a ML application local instance 128 that is specific to user A 102, and equips providers with information about ML application instance 122 for user A 102 and establishes traceability for all instance components 130 so that providers can navigate between the instance components 103 and ML application instance 122 for user A 102. ML application 126 and ML application local instance 128 are available to the provider tenancy 124 via the data science control plane 148 (shown in FIG. 1C).

In FIG. 1C, another portion of system 100 is shown having a data science service tenancy 146. This includes the data science control plane 148 in communication with a data repository 150, a ML pipeline 152 that is a collection of resources created by the data science control plane 148.

Data science control plane 148 is operable to create resources for model deployment 162, which includes multiple compute instances 164. Upon receiving the provisioning request (circle A), the data science control plane 148 generates and sends ML application instance 122 for user A to application service tenancy 108 (circle B), generates and sends ML application local instance 128 and ML application 126 to provider tenancy 124 (circles D and E), and populates some of the instance components 130 for ML application instance 122 for user A (circle F).

When Application PoD 116a for user A requests one or more predictions (circle C), the ML application data plane 156 in data science service tenancy 146 receives the request, operates a ML application router 158 to determine which ML model should be used for the requested predictions, operates a model deployment router 160 to determine how to use the selected ML model(s), and uses specific compute instances 164 to fulfill the request for a specific model deployment 162.

Data science control plane may also make use of existing multi-tenet cloud infrastructure resources 166 (data science or other) for generation of application components 140 and/or instance components 130.

System 100 may include a ML engine in some embodiments. Machine learning includes various techniques in the field of artificial intelligence that deal with computer-implemented, user-independent processes for solving problems that have variable inputs.

In some embodiments, the ML engine trains at least one ML model to perform one or more operations. Training a ML model involves using training data to generate a function that, given one or more inputs to the ML model, computes a corresponding output. The output may correspond to a prediction based on prior machine learning. In an embodiment, the output includes a label, classification, and/or categorization assigned to the respective input(s). The ML model corresponds to a learned model for performing the desired operation(s) (e.g., labeling, classifying, and/or categorizing inputs). For example, the ML model may be used in determining a likelihood of a certain collection of content representing a certain page in an interface.

In an embodiment, the ML engine may use supervised learning, semi-supervised learning, unsupervised learning, reinforcement learning, and/or another training method or combination thereof. In supervised learning, labeled training data includes input/output pairs in which each input is labeled with a desired output (e.g., a label, classification, and/or categorization), also referred to as a supervisory signal. In semi-supervised learning, some inputs are associated with supervisory signals and other inputs are not associated with supervisory signals. In unsupervised learning, the training data does not include supervisory signals. Reinforcement learning uses a feedback system in which the ML engine receives positive and/or negative reinforcement in the process of attempting to solve a particular problem (e.g., to optimize performance in a particular scenario, according to one or more predefined performance criteria). In an embodiment, the ML engine initially uses supervised learning to train the ML model and then uses unsupervised learning to update the ML model on an ongoing basis.

In an embodiment, the ML engine may use many different techniques to label, classify, and/or categorize inputs. The ML engine may transform inputs into feature vectors that describe one or more properties (“features”) of the inputs. The ML engine may label, classify, and/or categorize the inputs based on the feature vectors. Alternatively or additionally, the ML engine may use clustering (also referred to as cluster analysis) to identify commonalities in the inputs. The ML engine may group (i.e., cluster) the inputs based on those commonalities. The ML engine may use hierarchical clustering, k-means clustering, and/or another clustering method or combination thereof. In an embodiment, the ML engine includes an artificial neural network. An artificial neural network includes multiple nodes (also referred to as artificial neurons) and edges between nodes. Edges may be associated with corresponding weights that represent the strengths of connections between nodes, which the ML engine adjusts as machine learning proceeds. Alternatively or additionally, the ML engine may include a support vector machine. A support vector machine represents inputs as vectors. The ML engine may label, classify, and/or categorizes inputs based on the vectors. Alternatively or additionally, the ML engine may use a naïve Bayes classifier to label, classify, and/or categorize inputs.

Alternatively or additionally, given a particular input, the ML engine may apply a decision tree to predict an output for the given input. Alternatively or additionally, the ML engine may apply fuzzy logic in situations where labeling, classifying, and/or categorizing an input among a fixed set of mutually exclusive options is impossible or impractical. The aforementioned ML model and techniques are discussed for exemplary purposes only and should not be construed as limiting one or more embodiments.

In an embodiment, as the ML engine applies different inputs to a ML model, the corresponding outputs are not always accurate. As an example, the ML engine may use supervised learning to train the ML model. After training the ML model, if a subsequent input is identical to an input that was included in labeled training data and the output is identical to the supervisory signal in the training data, then output is certain to be accurate. If an input is different from inputs that were included in labeled training data, then the ML engine may generate a corresponding output that is inaccurate or of uncertain accuracy. In addition to producing a particular output for a given input, the ML engine may be configured to produce an indicator representing a confidence (or lack thereof) in the accuracy of the output. A confidence indicator may include a numeric score, a Boolean value, and/or any other kind of indicator that corresponds to a confidence (or lack thereof) in the accuracy of the output.

In one or more embodiments, an interface may refer to hardware and/or software configured to facilitate communications between a user and a computing device. An interface renders user interface elements and receives input via user interface elements. Examples of an interface include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of an interface are specified in different languages. The behavior of user interface elements is specified in a dynamic programming language, such as JavaScript. The content of user interface elements may be specified in a markup language, such as hypertext markup language (HTML) or XML User Interface Language (XUL). The layout of user interface elements is specified in a style sheet language, such as Cascading Style Sheets (CSS). Alternatively, an interface may be specified in one or more other languages, such as Java, C, or C++.

Additional embodiments and/or examples relating to computer networks which may be used to receive and/or transmit information for system 100 are described below in Section 4, titled “Computer Networks and Cloud Networks.”

In an embodiment, system 100 may be implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 3. Example Embodiments

Detailed examples are described below for purposes of clarity. Components and/or operations described below should be understood as one specific example which may not be applicable to certain embodiments. Accordingly, components and/or operations described below should not be construed as limiting the scope of any of the claims.

3.1 Instantiating a Machine Learning Instance

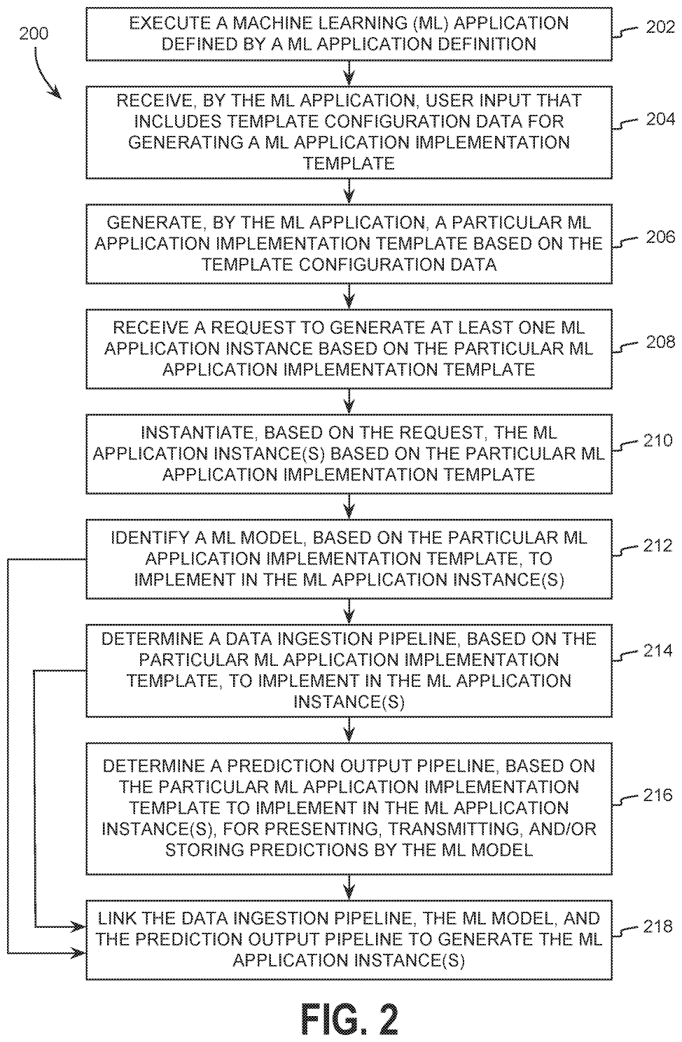

FIG. 2 illustrates an example method 200 for instantiating a ML application instance in accordance with one or more embodiments. Method 200, in one embodiment, may be performed by at least one hardware device that includes a hardware processor, referred to as a system. In another embodiment, method 200 may be performed by software instructions that are executed by a processor of a system. One or more operations illustrated in FIG. 2 may be modified, rearranged, or omitted all together. Accordingly, the particular sequence of operations illustrated in FIG. 2 should not be construed as limiting the scope of one or more embodiments.

In operation 202, the system executes a ML application defined by a ML application definition. In one embodiment, functionality for generating the ML application implementation template is made available by executing the ML application. The ML application may be configured to execute on one or more different operating systems and/or be configured to operate distributed across multiple devices.

According to one embodiment, the ML application definition may include a provisioning contract, a prediction contract, and/or a data contract. The provisioning contract specifies constraints on how ML application instances are provisioned within the requesting entity's existing software and hardware infrastructure/architecture, in an example. The prediction contract specifies constraints on how predictions are delivered based on data within the requesting entity's existing software and hardware infrastructure/architecture, in an example. The data contract specifies constraints on data (e.g., how data is stored, data format, locations, sizes, etc.) within the requesting entity's existing software and hardware infrastructure/architecture, in an example.

In operation 204, the system receives, by the ML application, user input that includes template configuration data for generating a ML application implementation template. The specific ML application implementation template that is generated may be based on any relevant information, which may include but is not limited to: a type of ML application instance, a function of the ML application instance, a type of source data, a type of target data, a type of prediction being sought, etc.

In an approach, the template configuration data may indicate for the ML application to configure a ML application instance within and/or to function with a requesting entity's existing software and hardware infrastructure/architecture.

In operation 206, based on the template configuration data the ML application generates a particular ML application implementation template. The particular ML application implementation template that is generated by the ML application, based on the template configuration data, may be used to instantiate multiple ML application instances.

In a further approach, at least a portion of the template configuration data may be received by the ML application, such as via a first set of one or more values that are entered into a first set of configuration fields of a user interface for configuring a ML application instance. In this approach, a ML application instance may be instantiated based on the first set of one or more values, as is possible given a set of constraints for instantiating the ML application instances as dictated by the particular ML application implementation template.

In accordance with an embodiment, the system may receive input in accordance with a set of constraints for generating the particular ML application implementation template. The set of constraints may dictate certain requirements for creating the particular ML application implementation template, such as a high level pattern that is desired by the requesting entity in generating their ML instances. In this way, the overall purpose, function, and/or goal of the ML application may be learned (such as via user input), and the system may generate the particular ML application implementation template based on the input dictated by the set of constraints.

In an embodiment, the system may receive input in accordance with a set of constraints for generating the ML application implementation template. The set of constraints may dictate any aspect of a ML application instance, such as purpose of the ML application instance, size of data, possible prediction outcomes, possible performance metrics, etc. The received input may include values or parameters that are used to instantiate the ML application instance. Some example input includes storage location(s); address(es) for functions, processes, and/or resources; I/O paths; etc. The system may use this input, in accordance with the set of constraints, to generate the ML application implementation template.

In operation 208, the system receives a request to generate and/or provision at least one ML application instance based on the particular ML application implementation template. In other words, the requesting entity asks for a ML application instance to be deployed based on a specific ML application implementation template. More than one ML application instance may be generated based on this request, with the number of ML application instances being instantiated being based on the request (e.g., a parameter in the request indicating the number of ML application instances to instantiate).

The ML application instance(s) will be deployed within and/or for use with the requesting entity's existing software and hardware infrastructure. One or more ML models may be included with the ML application instance(s) and each ML application instance will utilize the data of the requesting entity's existing software and hardware infrastructure/architecture and data that is ingested by the requesting entity's existing software and hardware infrastructure/architecture subsequent to deployment of the ML application instance(s) to generate predictions and/or train ML model(s) of the ML application instance(s).

In an embodiment, the request may specify one or more characteristics of an environment for the ML application instance(s). These characteristics may include, but are not limited to, operating system, formats and protocols used, sizes, data types, security and credential information to access components within the environment, which data to access, where data is located, etc. In a further embodiment, the system may determine the data ingestion pipeline, the ML model, and/or the prediction output pipeline as a function of the one or more characteristics of the environment for the ML application instance(s).

According to an embodiment, the request may specify one or more characteristics of the source data. These characteristics may include, but are not limited to, a format of the data, a protocol associated with the data, a size of at least a portion of the source data, a storage location for the data, etc. In this embodiment, the system may determine the data ingestion pipeline, the ML model, and/or the prediction output pipeline as a function of the one or more characteristics of the source data.

In operation 210, the system instantiates, based on the request, the ML application instance(s) based on the particular ML application implementation template. Instantiating the ML application instance(s) may include, in an embodiment, operations 212, 214, 216, and 218, described below. More or less operations may be included in instantiating the ML application instance(s) of the particular ML application implementation template in various approaches.

ML deployment, ML model deployment, ML deployment pipeline, ML application instance, and ML pipeline may be used for an end-to-end ML use case which may be configured for, but is not limited to, ingestion of source data, transformation of the source data into an appropriate format for ML model training, ML model training using the transformed data, and deployment and prediction services to deliver predictions based on the ML model(s).

In operation 212, the system identifies a ML model, based on the particular ML application implementation template, to implement in the ML application instance(s). The system may have access to a library of ML models to choose from, with each ML model in the library being associated with the particular ML application implementation template. Moreover, the various ML models may be configured for particular use cases, types of data, size of data, etc. In one approach, more than one ML model may be identified for the ML application instance(s), with certain conditions or triggers being specified to dictate which ML model is used under various operating conditions. In a further embodiment, different ML application instances may be instantiated with different ML models.

According to one embodiment, the ML model may include a trained ML model for use in making predictions. In an embodiment, the ML model may include an algorithm that is usable to generate the trained ML model (e.g., through training with sets of training data prior to being used to generate predictions).

In operation 214, the system determines and/or generates a data ingestion pipeline, based on the particular ML application implementation template, to implement in the ML application instance(s). In other words, the system has access to a library of data ingestion pipeline templates, with each of the data ingestion pipeline templates being associated with some aspect or characteristic of the use case for which the data ingestion pipeline is to be used.

In one or more embodiments, data ingestion pipelines (and ML pipelines) are configured to act as a template and allow for spawning of additional pipelines that are parameterized for a specific user. Accordingly, not only does this configuration allow for having pipelines, but also for having templates of pipelines. Therefore, either a pipeline template is used to instantiate a new pipeline or a pipeline that is part of the particular ML application implementation may be used directly within a ML application instance (as many instances may use the same pipeline resource and/or instance).

In one embodiment, the data ingestion pipeline template defines a set of one or more transformation operations configured to transform source data to target data for application of the ML model.

In one embodiment, the transformation operation(s) may change a format of the source data into a format suitable for use with the ML model. In an embodiment, the transformation operation(s) may add and/or remove portions of the source data to transform it into the target data for use with the ML model, such as encoding, decoding, removing headers, adding headers, processing in accordance with one or more established protocols, etc.

In operation 216, the system determines and/or generates a prediction output pipeline for presenting, transmitting, and/or storing predictions made by the ML model. The prediction output pipeline, to implement in the ML application instance(s), may be determined based on the particular ML application implementation template. In other words, the system has access to a library of prediction output pipeline templates, with each of the prediction output pipeline templates being associated with the particular ML application implementation template.

In operation 218, the system links (e.g., packages together) the data ingestion pipeline, the ML model, and the prediction output pipeline to generate the ML application instance. Each of these three components work together to deliver the ML model functionality to the requesting entity's existing software and hardware infrastructure/architecture.

In one or more embodiments, the ML application instance may include functionality to perform any of the following operations: transform the source data to the target data using the set of one or more transformation operations, apply the ML model to the target data to generate the predictions by the ML model, present the predictions by the ML model, transmit the predictions by the ML model, and/or store the predictions by the ML model.

According to an embodiment, the system may execute operations as defined by the particular ML application implementation template.

In a further embodiment, the ML application instance may include functionality to train the ML model(s) included therein. The training may be performed based on detection of one or more triggering conditions. Some example triggering conditions include, but are not limited to: a period of time elapsing since a last training, receipt of new source data via the data ingestion pipeline, a restart of some portion of the requesting entity's existing software and hardware infrastructure/architecture, a failure in the ML application instance, metrics associated with the ML application instance not meeting a designated target, etc.

In one approach, the ML application may perform method 200 to provision and/or instantiate at least one ML application instance. The ML application may operate as SaaS in a further approach, for use by multiple requesting entities.

The ML application may, in one or more embodiments, monitor a group of ML application instances (including the ML application instance obtained in operation 210), and generate an alert indicating an issue with at least one particular ML application instance of the group of ML application instances. In this way, the ML application may analyze fleet model performance for instantiated ML application instances.

According to an embodiment, the system may instantiate a fleet of ML application instances using one or more ML application implementation templates. The system may compute performance metrics across the fleet of ML application instances, and once the performance metrics have been computed, the system may aggregate the performance metrics across the fleet of ML application instances to compute an aggregated performance score for the fleet of ML application instances. In this way, the system may manage, based on specific performance metrics applicable across the entire fleet of ML application instances, all of the ML application instances in the fleet.

Some example performance metrics include, but are not limited to, quality of a ML model, accuracy of a ML model, accuracy of predictions provided by the ML model, frequency of predictions being chosen, quantity of predictions delivered prior to a selection being made, etc.

In one or more embodiments, the system may generate a dashboard UI to present the aggregated performance metrics across the fleet of ML application instances. The system may display the dashboard UI on a display of a computing device for interaction or observation by a user.

In an approach, the system may apply the ML application instance to the source data to generate the predictions by the ML model. Of course, the system may perform this operation for any ML application instances that are maintained by the system, delivering the ML model predictions as a service for the requesting entity, alleviating the requesting entity from needing to execute processes upon their own hardware and software infrastructure/architecture, in an approach.

In an embodiment, the request may specify one or more characteristics of an environment for the ML application instance. In this embodiment, at least one of the data ingestion pipeline, the ML model, and the prediction output pipeline may be determined as a function of the characteristic(s) of the environment for the ML application instance. Some example characteristics include, but are not limited to, operating system, storage size, rate of data ingestion, rate of prediction output, type of use case, data format(s), etc.

According to one embodiment, the request may specify one or more characteristics of the source data. In this embodiment, the system may determine at least one of the data ingestion pipeline, the ML model, and the prediction output pipeline as a function of the one or more characteristics of the source data. Some example characteristics include, but are not limited to, rate of source data ingestion, type of use case, source data format(s), etc.

The prediction output pipeline may include functionality to generate batch predictions and real-time predictions for a set of ML application instances, in various approaches. Batch predictions are generated based on training ML models in batches or groups using a training data set at approximately the same time, after which predictions may be obtained from the various ML models based on the just completed training. Real-time predictions are delivered by a ML model upon request, based on existing or real-time data.

In one embodiment, the user (such as a software developer) may create a “package” in source control that includes information used in instantiating ML application instances. The user calls an API associated with the ML application, which passes the package and requests the system to use the contents of the package (such as information about desired data and ML pipelines) to generate a ML application implementation template. The generated ML application implementation template can subsequently be used by the user to create one or more ML application instances.

3.2 Provisioning Multiple Machine Learning Deployment Pipelines Based on a Machine Learning Deployment Pipeline Template

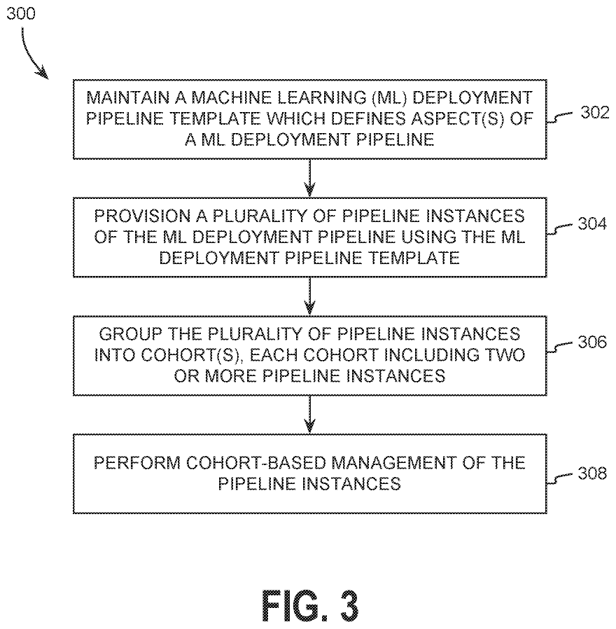

FIG. 3 illustrates an example method 300 for provisioning multiple ML deployment pipelines based on a ML deployment pipeline template, in accordance with one or more embodiments. Method 300, in one embodiment, may be performed by at least one hardware device that includes a hardware processor, referred to as a system. In another embodiment, method 300 may be performed by software instructions that are executed by a processor of a system. One or more operations illustrated in FIG. 3 may be modified, rearranged, or omitted all together. Accordingly, the particular sequence of operations illustrated in FIG. 3 should not be construed as limiting the scope of one or more embodiments.

ML applications, ML application implementations, application components, instance components/templates, ML application instances, and ML pipelines together represent an end-to-end ML use case which may be configured for, but is not limited to, ingestion of source data, transformation of the source data into an appropriate format for ML model training, ML model training using the transformed data, and deployment and prediction services to deliver predictions based on the ML model(s).

ML deployment, ML model deployment, and ML deployment pipelines work together to deploy an ML application service. A Cl/CD process (continuous integration/continuous deployment) deploys ML applications and their implementations. An ML application service creates ML applications and their implementations. Upon actions executed by users and/or systems, the ML application service runs workflows and manipulates ML applications, ML application implementations, and ML application instances. In other words, the ML application service ensures that application components are created, instance component templates are stored, instance component templates are used to create instance components, etc. ML Pipelines, which are application components, are used to orchestrate ML workflows.

In operation 302, the system maintains a ML deployment pipeline template. The ML deployment pipeline template defines one or more aspects of a ML deployment pipeline. In one or more embodiments, the ML deployment pipeline template may include a definition for ingestion of data. In one or more embodiments, the ML deployment pipeline template may include a definition for transformation of data for at least one ML model training. In one or more embodiments, the ML deployment pipeline template may include a definition of at least one ML model. In one or more embodiments, the ML deployment pipeline template may include a definition of at least one ML model training. In one or more embodiments, the ML deployment pipeline template may include a definition of at least one ML model deployment. In one or more embodiments, the ML deployment pipeline template may include a definition of serving at least one ML model prediction.

In operation 304, the system provisions a plurality of pipeline instances of the ML deployment pipeline, using the ML deployment pipeline template as a basis for each of the plurality of pipeline instances. In this way, multiple pipeline instances may be efficiently provisioned for delivering ML functionality to software providers' existing software environments without needing individual training of a ML model based on the software provider's relevant data for each instance of the ML deployment pipeline.

In an embodiment, each pipeline instance of the plurality of pipeline instances may be configured to customize a ML model based on characteristics associated with each pipeline instance. These characteristics may include any relevant detail regarding the individual pipeline instances, such as specific use cases, relevant data, number of users, purpose of the pipeline instance, relative sizes of I/O, etc.

In one embodiment, the system delivers one or more predictions, of a first ML model customized by a first pipeline instance of the plurality of pipeline instances, to a user device as a service (such as SaaS, cloud computing, etc.) based on a request from the user device. In this way, a logical service may offer ML model generated predictions to address some issue, problem, choice, or other quandary of a user device based on the user device requesting such aid.

In a further embodiment, the request may be an application programming interface (API) call configured to trigger the prediction service to respond with relevant predictions. In this embodiment, the ML deployment pipeline template may include a definition specifying how to serve ML model prediction(s) to a generic user device including formats, protocols, sizes, data types, which ML model(s) to use, which data to access, where data is located, and/or any other relevant information to enact a connection between the ML model's predictions and the user device. Further, in an approach the API call conforms to the definition from the ML deployment pipeline template specifying how to serve the ML model prediction(s).

According to an embodiment, the ML deployment pipeline template defines application-level component(s) and/or instance-level component(s). In this embodiment, an instance of each of the application-level component(s) may be instantiated for each of the pipeline instances, and/or an instance of each of the instance-level component(s) may be instantiated for each of the pipeline instances. In this way, the ML deployment pipeline template may selectively define application-level components and/or instance-level components for use in any of the pipeline instances provisioned based on the ML deployment pipeline template.

In a further embodiment, the pipeline instances may include, for example, a first pipeline instance and a second pipeline instance. A first instance-level component instantiated for the first pipeline instance may be accessible by the first pipeline instance while not being accessible by the second pipeline instance. In addition, a second instance-level component instantiated for the second pipeline instance may be accessible by the second pipeline instance while not being accessible by the first pipeline instance. In other words, instance-level components are not shared across ML pipeline instances, according to one approach.

In an approach, the system may include grouping the pipeline instances into one or more groups. Each of the group(s) may include two or more pipeline instances. In other words, groups do not include a single pipeline instance in this approach. The system may maintain one or more target distributions of metrics for the group(s). A target distribution of metrics may specify or define certain aspects of pipeline instance(s) that are desired to be achieved. Some example metrics for which target distributions may be formulated include, but are not limited to, quality of a ML model, accuracy of a ML model, accuracy of predictions, frequency of a user choosing a prediction, quantity of predictions delivered to a user before making a selection, etc. In a further approach, the system may generate, obtain, and/or acquire metrics associated with the various groups. From these gathered metrics, the system may determine whether the metrics for each of the various groups satisfies the target distribution(s) of metrics. In other words, the individual metrics of the various groups may be compared to a threshold. In an example, for groups which do not meet the threshold in terms of metrics, the pipeline instances within those substandard groups may be removed from service and/or flagged for updating and/or adjustment.

In one or more embodiments, the group(s) may be identified based, at least in part, on clustering of metrics reflecting ML model performance for each pipeline instance of the plurality of pipeline instances. In other embodiments, the group(s) may be identified based on some other aspect of the pipeline instances. In either case, groups may be defined by clustering together pipeline instances which share some observable or quantifiable similarity.

According to one embodiment, as an example, the group(s) may include a first group and a second group. In this example, the system may perform a first update on the pipeline instances of the first group at a first time and perform a second update on the pipeline instances of the second group at a second time. The second time may be different than the first time, illustrating that the system is configured for group-based management of the pipeline instances.

In one approach, the first update is different from the second update, which may be performed at the same time or different times. In another approach, the first and second updates may be the same, and are performed by the system at different times.

The system may also maintain a second ML deployment pipeline template different from the ML deployment pipeline template of operation 302. Here, the system may provision a second set of pipeline instances of the second ML deployment pipeline using the second ML deployment pipeline template. This allows the system to manage versioning of the pipeline template, in that the second ML deployment pipeline template may be based on, but unique from, the ML deployment pipeline template in operation 302.

3.3 Machine Learning as a Service on Demand

In one or more embodiments, a software service (e.g., ML application) is delivered that allows for software providers to introduce and support ML-based features into the software provider's software suites. Each ML-based feature may be a discrete packaged ML application that is definable and maintained centrally, but provisioned for each user of the software provider on an as-needed basis. The central definition encapsulates the data science processes and refinements, while still allowing the ML-based features to be replicated as separate tailored runtime instances per user. Because each user's data is different, the tailored ML-based feature will also be unique to that user when trained based on their data.

A centrally maintained ML application, which is defined by a ML application definition, may be used to generate a plurality of ML application implementation templates. Each separate software provider may have a specialized interface for maintaining and defining the ML application, along with their own software suites that interact with the ML application instances representing single ML pipelines (e.g., to request/make/receive a prediction).

While each ML application instance is based on the same ML application implementation, their runtimes (with respect to data usage) are isolated from one another, to satisfy common software provider requirements of separation between users.

ML application includes a stable provisioning contract (common to SaaS deployments), which may be defined to allow an API call to trigger provisioning of a ML application instance for a particular user of the software provider. A stable data contract may be used to determine the shape and schema of the target data for the ML application in order to train and deploy one or more prediction serving endpoints (which may be online or endpoints that retrieve data from batch mode predictions). A stable data contract allows the provisioning system (e.g., SaaS) to provision the ML application instance regardless of which ML Application implementation is used. The provisioning system may decide to use a specific implementation based on the request or a characteristic of the user (e.g., tenant). In another approach, the user may decide to use a specific ML application implementation of the ML application—including the scenario when the user (e.g., tenant) provides their own implementation. In such a case, the user's implementation will be used by the SaaS system the same way as the default ML application implementation without affecting any functionality inside the SaaS system which would require updates to the SaaS system.

Also, a stable prediction contract may be used to define the shape of the request and response to get one or more predictions or recommendations for the ML application. ML application also supports versioning, that allows the software provider, within constraints of the stable contracts, to manage one or more versioned implementations of the ML application instances. The software provider is able to evolve their product suite, including the underlying data science, to iteratively improve the solution and generalize it for a fleet of users.

A code/metadata approach to defining the components of the ML application allows the software provider flexibility in in how they deliver their implementation. Specifically, ML application allows the software providers to define their application components (that are instantiated once for all instances) and instance components that are instantiated once per pipeline and tailored as needed for the scenario. For example, an instance component of an object storage bucket may be defined, where this bucket will be only accessible for the particular pipeline for which it was created, and not accessible by any other pipelines.

Moreover, any existing cloud infrastructure service (data science or other) may be used as application or instance components. This allows the software provider to compose a solution using the full breadth of their capabilities in the cloud infrastructure. As the particular cloud infrastructure adds and enhances services, these new capabilities are available to users of the software suite.

The functionality is directly related into a “blueprint” which may be used to generate a fleet of ML application instances, contrary to established ML Ops, where various operational tasks are established for a single pipeline. Example operational tasks include monitoring and alerting on the pipelines and processes to observe general health (e.g., service level agreements), data health, model health, etc. ML application allows for all of these operational tasks to be established, but instead of applying to a single pipeline, a central definition states operational expectations at the fleet level.

Some fleet-level capabilities include group definitions, which are ways to group pipelines into a group of ML application instances (e.g., using user-specific information). Groups formed in this way may be used as a subset of pipelines (relative to the entire set of pipelines for a given ML application) when applying fleet management. Fleet management may include model performance clustering analysis, fleet model performance, ML application version fleet rollout, and basic usage tracking.

Model performance clustering analysis allows groups to be formed based on model performance relating to training data and other user characteristics. Fleet model performance allows for each model that is being trained to have various metrics computed to represent the quality of the model. Target distributions of metrics may be set and actual performance may be compared against these target distributions at the fleet level. For example, it may be desired that 99% of the fleet of models are each attaining a quality metric value of >x. Fleet model performance can be queried, monitored, and alerted on when certain conditions arise.

ML application version fleet rollout allows for specific rollout strategies, such as, rollout version to all users (e.g., all pipelines in the fleet), rollout in ring deployment (expanding rollout over time using rollout rules or series of groups), shadow deployment of versions of ML applications for shadow evaluation of fleet model performance (where positive performance measured against non-updated pipelines would trigger a rollout), and gating of version deployment based on fleet model performance (to ensure that fleet performance goals are not degraded due to ML application implementation updates).

Basic usage tracking answers questions about the fleet, such as how many pipelines (users) are existing, their individual lifecycle states, how many predictions are being served, trending on usage tracking allowing for churn prediction or intervention, etc.

Some other fleet-level capabilities include encapsulation of a data science solution at the level that is needed to embed in large enterprise sized solutions (e.g., SaaS). This is achieved through provisioning, data, and prediction contracts. Versioned evolution is available that evolves along with the user's data, through ML model training and algorithm optimization.

In one embodiment, a metadata layer is generated for the ML application that allows a software provider to pick a “pattern template” for their ML application. This pattern template is then filled with the minimal information needed for the specific ML use case developed by the software provider. ML application takes care of the creation of internal implementation based on the filled pattern template. A custom pattern template may be defined by the software provider when standard pattern templates do not fulfill the use case for the software provider. The custom pattern template may be created to represent a best practice and only expose the use case specifics to the users of the pattern template.

Although ISV and SaaS use cases are described above, ML application may be used in other use cases. For an enterprise entity that wants packaging, reproducibility, and replicability. The ML application solves the need to package up the work done by their data scientists and ML engineers into something that can be faithfully and accurately recreated as needed in any number of environments. For example, a large multinational company may want to use a core ML based feature in each of their global regions but are not allowed to create one instance due to data residency requirements. Instead, one ML application can be created by a central group and an instance deployed in each region. The provider team can monitor and update the fleet of instances as described above.

An enterprise entity wanting to replace independent software vendors (ISVs) delivered data science, where end customers have their own data science teams who wish to replace delivered algorithms in software they purchase from ISVs, may use ML application. A segmentation feature may be delivered, based on ML, to create segments of users to target, e.g., for a marketing campaign. Because ML application defines a contract and an implementation means the entity can replace a delivered implementation with their own and still have the application work correctly. Also, an ML application marketplace would allow any software provider to deliver ML application implementations that customers could then choose as their needs dictate.

ML application has certain advantages. Without ML application, providers of ML-based solutions (where there is a need for a multiplicity of instances or pipelines) have to create all of the above described capabilities themselves to have the comprehensive solution they need. A provider could try to roll out their own solution, which introduces severe challenges.

Trying to embed ML into SaaS is an immense effort. ML application has huge savings in terms of effort. Not only do the known solutions of existing software and data science platforms have to be used as building blocks, the software provider would not understand the issues that arranging these components together presents. Therefore, trial and error would be needed to arrive at a somewhat useful solution. For example, the tools needed to achieve model generalization for the fleet (good performance for fleet as a whole) would not be evident to a data scientist.

3.4 Machine Learning Architecture

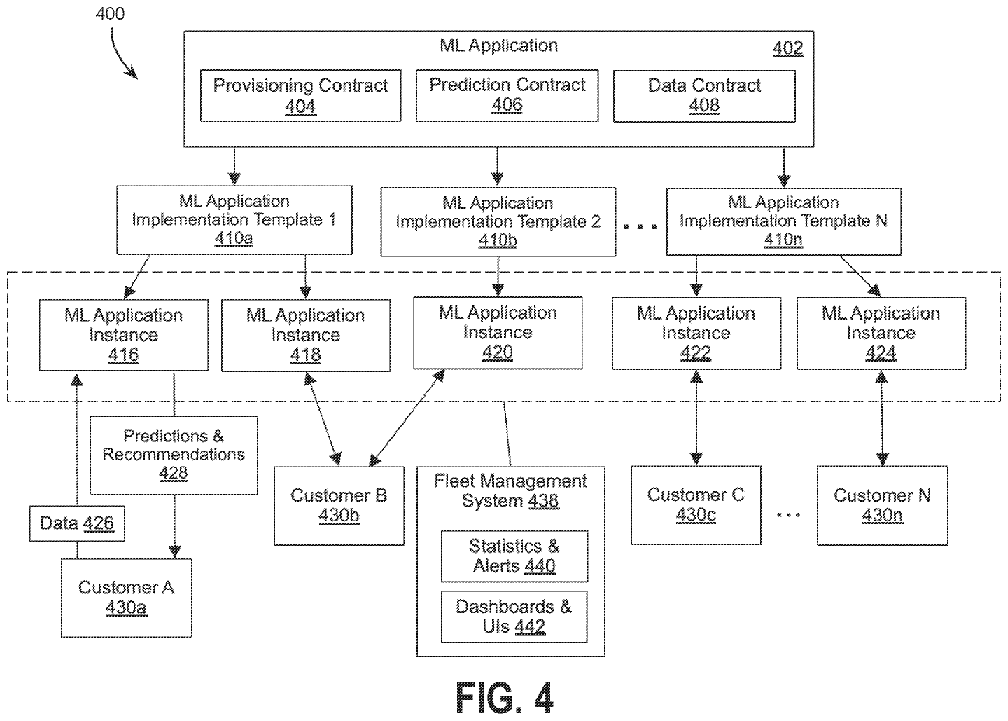

FIG. 4 illustrates an example ML architecture 400, in accordance with one or more embodiments. ML architecture 400 includes a ML application 402 which is configured to communicate with any number of customer devices (e.g., Customer 430a, Customer 430b, Customer 430c, . . . , Customer 430n).

ML application 402 is defined by a ML application definition and is configured to generate one or more ML application implementation templates (e.g., ML application implementation template 410a, ML application implementation template 410b, ML application implementation template 410n). The ML application definition may include one or more of the following: a provisioning contract, a prediction contract, and a data contract, as described previously.

Each ML application implementation template is configured to allow a system to instantiate, upon request by a user or some application or device, one or more ML application instances that share the same fundamental features and structure as their respective ML application implementation template. For example, ML application instances 416 and 418 are instantiated from ML application implementation template 410a and share its fundamental features and structure. In another example, ML application instance 420 is instantiated from ML application implementation template 410b and ML application instances 422 and 424 are instantiated from ML application implementation template N 414.

Based on a request to instantiate one or more ML application instances, a ML application instance (e.g., ML application instance 416) of a ML application implementation template (e.g., ML application implementation 410a) is instantiated using at least the following procedure: (a) storage is allocated (e.g., a bucket, database, stat lake, etc.), (b) a data ingestion pipeline is determined based on the ML application implementation template to implement in the ML application instance, (c) a prediction output pipeline is determined based on the ML application implementation template to implement in the ML application instance, and (d) the data ingestion pipeline, the ML model, and the prediction output pipeline are linked together to generate the first ML application instance.

All instance components are created during instantiation, including ML pipeline(s) (e.g., a training pipeline to train and deploy an ML model, hyper-parameter tuning pipeline, batch prediction pipeline to calculate predictions, monitoring pipeline(s) to monitor model and data quality, etc.). ML models can be pre-trained and deployed from the beginning, instantiated before instance creation or during instance creation. Moreover, ML models are produced by execution of training pipeline(s) in some approaches.

The prediction output pipeline is configured to present, transmit, and/or store batch predictions 428 by the ML model. Real-time predictions 428 are handled by model deployment, an ML application instance component that may use HTTP endpoint(s) and apply models to incoming data providing immediate predictions. Therefore, the predictions 428 may be batch predictions and/or real-time predictions in various embodiments.

In one embodiment, the data ingestion pipeline defines a set of one or more transformation operations configured to transform source data 426 to target data for application of the ML model.

Different customers may be coupled to different ML application instances instantiated from the same ML application 402. For example, Customer 430c is coupled to exchange information with ML application instance 422 while Customer 430n is coupled to exchange information with ML application instance 424. In another example, Customer 430b is coupled to multiple ML application instances: ML application instance 418 and ML application instance 420.

In one embodiment, ML architecture 400 may also include a fleet management system 438, which is configured to generate statistics and alerts 440, and delivers dashboards and user interfaces 442 for displaying and analyzing the various statistics and alerts 440. Moreover, the statistics and alerts 440 are based on the various predictions and recommendations 428 delivered by one or more ML application instances instantiated from the ML application 402.

3.5 Machine Learning Application Details

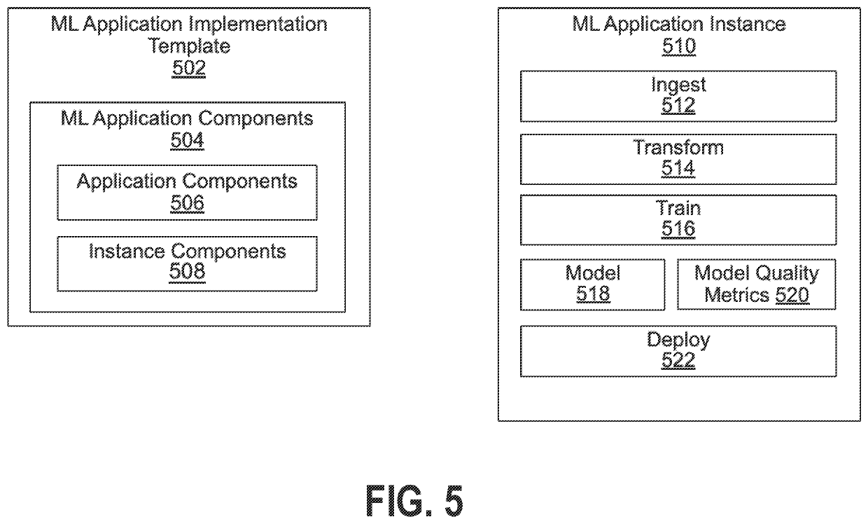

FIG. 5 illustrates an example ML application implementation template 502 and an example ML application instance 510, in accordance with one or more embodiments. ML application implementation template 502 and/or ML application instance 510 may be utilized in ML architecture 400 of FIG. 4, in one or more embodiments.

Referring again to FIG. 5, ML application implementation template 502 includes ML application components 504, which may further include application components 506 and instance components 508, all of which may be used when instantiating a ML application instance based on the ML application implementation template 502.

The application components 506 may be used for provisioning, managing, maintaining, and/or supporting ML application instances across various users. The application components 506 are shared across various ML application instances. Application components 506 may include a data ingestion pipeline and a ML pipeline, in one or more approaches.

The instance components 508 may be used for provisioning, managing, maintaining, and/or supporting a specific ML application instance. The instance components 508 are specific to one single ML application instance for a particular Customer and are not used by any other ML application instances. Instance components 508 include one or more data ingestion triggers which define conditions and/or situations where the data ingestion pipeline will operate to ingest source data, along with possible constraints and/or limits on that source data.

ML application instance 510 includes an ingest pipeline 512, a transform module 514, a training module 516, a ML model 518, ML model quality metrics 520, and a deployment pipeline 522. The ingest pipeline 512 is configured to ingest source data and any other relevant information useful for applying the ML model 518, in one approach. The transform module 514 is configured to transform the source data into an appropriate format for ML model training, in an approach. The appropriate format may be included in the ML model 518 and/or may be specified by a user. The training module 516 is configured to train the ML model 518 using the transformed data (after the transform module 514 has transformed the source data), in an approach. The deployment pipeline 522 is configured to deploy the ML model 518, which can deliver prediction services based on application of the ML model 518. Model quality metrics 520 track the effectiveness and accuracy of predictions made by ML model 518, for further refinement and analysis.

### 4. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a NAT. Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an API.

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 5. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

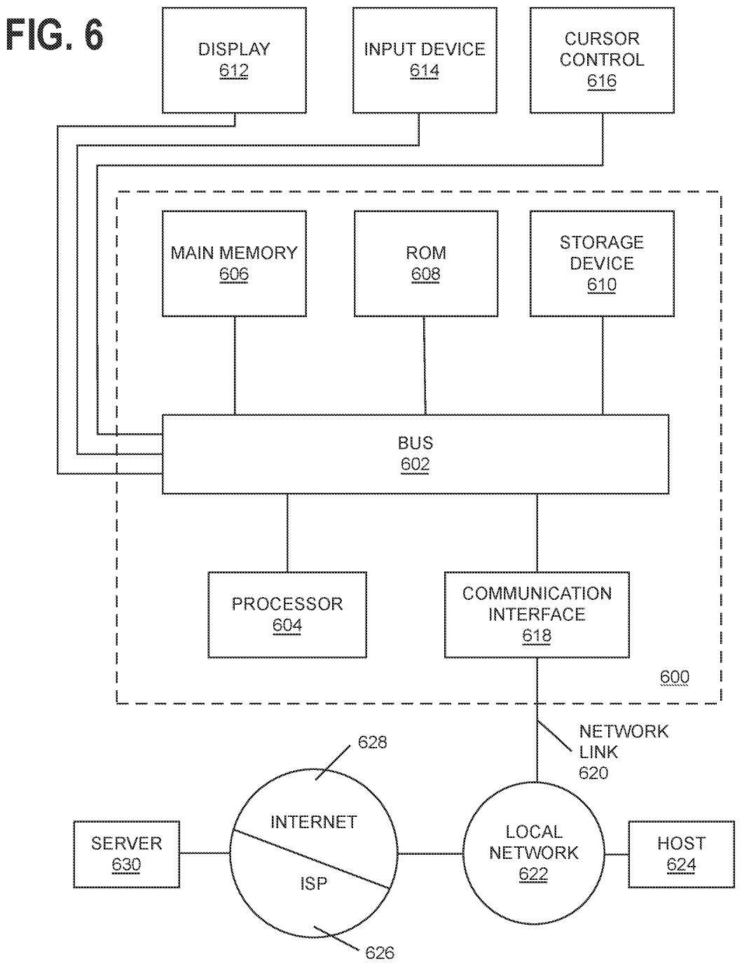

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
executing a machine learning (ML) application defined by a ML application definition;
receiving, by the ML application, user input comprising template configuration data for generating a ML application implementation template;
based on the template configuration data: generating, by the ML application, a particular ML application implementation template;
receiving a request for generation of a first ML application instance based on the particular ML application implementation template; and
instantiating, based on the request, the first ML application instance based on the particular ML application implementation template.

2. The one or more non-transitory computer readable media as recited in claim 1, wherein the first ML application instance is instantiated at least by:
identifying a ML model based on the particular ML application implementation template to implement in the first ML application instance;
determining a data ingestion pipeline based on the particular ML application implementation template to implement in the first ML application instance;
determining a prediction output pipeline based on the particular ML application implementation template to implement in the first ML application instance, the prediction output pipeline being configured to present, transmit, and/or store predictions by the ML model; and
linking the data ingestion pipeline, the ML model, and the prediction output pipeline to generate the first ML application instance.

3. The one or more non-transitory computer readable media as recited in claim 2, wherein the ML model comprises one of: (a) a trained ML model, or (b) an algorithm usable to generate a trained ML model.

4. The one or more non-transitory computer readable media as recited in claim 2, wherein linking the data ingestion pipeline, the ML model, and the prediction output pipeline to generate the first ML application instance comprises executing operations as defined by the particular ML application implementation template.

5. The one or more non-transitory computer readable media as recited in claim 2, wherein the data ingestion pipeline defines a set of one or more transformation operations configured to transform source data to target data for application of the ML model.

6. The one or more non-transitory computer readable media as recited in claim 2, wherein the operations further comprise:
applying the particular ML application instance to the source data to generate the predictions by the ML model.

7. The one or more non-transitory computer readable media as recited in claim 2,
wherein the request specifies one or more characteristics of an environment for the particular ML application instance, and
wherein at least one of (a) the data ingestion pipeline, (b) the ML model, and (c) the prediction output pipeline are determined based on the one or more characteristics of the environment for the particular ML application instance.

8. The one or more non-transitory computer readable media as recited in claim 2,
wherein the request specifies one or more characteristics of the source data, and
wherein at least one of the data ingestion pipeline, the ML model, and the prediction output pipeline are determined based on the one or more characteristics of the source data.

9. The one or more non-transitory computer readable media as recited in claim 2, wherein the prediction output pipeline comprises functionality to generate batch predictions and real-time predictions.

10. The one or more non-transitory computer readable media as recited in claim 1, wherein the user input is received in accordance with a set of constraints for generating the particular ML application implementation template.

11. The one or more non-transitory computer readable media as recited in claim 1, wherein instantiating the first ML application instance based on the particular ML application implementation template comprises:
receiving a first set of one or more values for a first set of configuration fields; and
instantiating the first ML application instance based on the first set of one or more values.

12. The one or more non-transitory computer readable media as recited in claim 1, wherein the ML application definition comprises at least one of: a provisioning contract, a prediction contract, and a data contract.

13. The one or more non-transitory computer readable media as recited in claim 1, wherein the operations further comprise:
instantiating a fleet of ML application instances using one or more ML application implementation templates;
computing performance metrics across the fleet of ML application instances; and
aggregating the performance metrics across the fleet of ML application instances to compute an aggregated performance score for the fleet of ML application instances.

14. The one or more non-transitory computer readable media as recited in claim 13, wherein the operations further comprise:
generating a dashboard to present the aggregated performance metrics across the fleet of ML application instances; and
displaying the dashboard on a display of a computing device.

15. The one or more non-transitory computer readable media as recited in claim 1, wherein the particular ML application instance comprises functionality at least to:
transform source data to target data using a set of one or more transformation operations;
apply one or more ML models to the target data to generate predictions by the one or more ML models; and
present, transmit, and/or store the predictions by the one or more ML models.

16. The one or more non-transitory computer readable media as recited in claim 15,
wherein the particular ML application instance comprises functionality to train the one or more ML models based on detection of a triggering condition, and
wherein the triggering condition comprises at least one of: a period of time elapsing since a last training, receipt of new source data via a data ingestion pipeline, and performance metrics indicating a quality of the predictions generated by the one or more ML models falling below a performance threshold.

17. The one or more non-transitory computer readable media as recited in claim 1, wherein the operations further comprise:
monitoring, by the ML application, a plurality of ML application instances that include the first ML application instance; and
generating, via the ML application, an alert indicating an issue with at least one particular ML application instance of the plurality of ML application instances.

18. One or more non-transitory computer readable media comprising instructions which, when executed by one or more hardware processors, cause performance of operations comprising:
maintaining a machine learning (ML) deployment pipeline template, which defines one or more aspects of a ML deployment pipeline, the ML deployment pipeline template comprising one or more of: a definition for ingestion of data, a definition for transformation of data for at least one ML model training, a definition of at least one ML model, a definition of at least one ML model training, a definition of at least one ML model deployment, and a definition of serving at least one ML model prediction; and
provisioning a plurality of pipeline instances of the ML deployment pipeline using the ML deployment pipeline template,
wherein each pipeline instance of the plurality of pipeline instances is configured to customize a ML model based on characteristics associated with each pipeline instance.

19. The one or more non-transitory computer readable media as recited in claim 18, wherein one or more predictions, of a first ML model customized by a first pipeline instance of the plurality of pipeline instances, are delivered to a user device as a service based on a request from the user device.

20. The one or more non-transitory computer readable media as recited in claim 19, wherein the request is an application programming interface (API) call, wherein the ML deployment pipeline template comprises a definition of serving at least one ML model prediction, and wherein the API call conforms to the definition of serving the at least one ML model prediction.

21. The one or more non-transitory computer readable media as recited in claim 18,
wherein the ML deployment pipeline template defines one or more application-level components and one or more instance-level components,
wherein an instance of each of the one or more application-level components is instantiated for the plurality of pipeline instances, and
wherein an instance of each of the one or more instance-level components is instantiated for each pipeline instance of the plurality of pipeline instances.

22. The one or more non-transitory computer readable media as recited in claim 21,
wherein the plurality of pipeline instances comprises a first pipeline instance and a second pipeline instance,
wherein a first instance-level component instantiated for the first pipeline instance is accessible by the first pipeline instance and is not accessible by the second pipeline instance, and
wherein a second instance-level component instantiated for the second pipeline instance is accessible by the second pipeline instance and is not accessible by the first pipeline instance.

23. The one or more non-transitory computer readable media as recited in claim 18, wherein the operations further comprise:
grouping the plurality of pipeline instances into one or more groups, each group of the one or more groups comprising two or more pipeline instances.

24. The one or more non-transitory computer readable media as recited in claim 23, wherein the operations further comprise:
maintaining one or more target distributions of metrics for the one or more groups; and
determining whether metrics generated for each of the one or more groups satisfies the one or more target distributions of metrics.

25. The one or more non-transitory computer readable media as recited in claim 23, wherein the one or more groups are identified based, at least in part, on clustering of metrics reflecting ML model performance for each pipeline instance of the plurality of pipeline instances.

26. The one or more non-transitory computer readable media as recited in claim 23, wherein the one or more groups comprise a first group and a second group, and wherein the operations further comprise:
performing a first update on the pipeline instances of the first group at a first time; and
performing a second update on the pipeline instances of the second group at a second time,
wherein the second time is different than the first time.

27. The one or more non-transitory computer readable media as recited in claim 26, wherein the first update is different from the second update.

28. The one or more non-transitory computer readable media as recited in claim 18, wherein the ML deployment pipeline template is a first ML deployment pipeline template, and wherein the operations further comprise:
maintaining a second ML deployment pipeline template, which is different than the first ML deployment pipeline template; and
provisioning a second plurality of pipeline instances of the second ML deployment pipeline using the second ML deployment pipeline template.

29. The one or more non-transitory computer readable media as recited in claim 28, wherein the second ML deployment pipeline template is based on, but unique from, the first ML deployment pipeline template.
